(19) United States
(12) Patent Application Publication
(10) Pub. No.: US 2024/0173923 A1
(43) Pub. Date: May 30, 2024

(54) Three-Dimensional Shaped Object Manufacturing Method And Information Processing Device

(71) Applicant: SEIKO EPSON CORPORATION, Tokyo (JP)

(72) Inventor: Shigeru YAMAZAKI, Shiojiri (JP)

(21) Appl. No.: 18/520,969

(22) Filed: Nov. 28, 2023

(30) Foreign Application Priority Data
Nov. 29, 2022 (JP) 2022-190379

(51) Int. Cl. B29C 64/393; B29C 64/112; B29C 64/118; B29C 64/124; B29C 64/209; B29C 64/245; B33Y 10/00; B33Y 50/02

(52) U.S. Cl. CPC B29C 64/393; B29C 64/112; B29C 64/118; B29C 64/124; B29C 64/209; B29C 64/245; B33Y 10/00; B33Y 50/02

(57) ABSTRACT

A three-dimensional shaped object manufacturing method includes: generating shaping data including path data; and shaping, based on the shaping data, a shaped object and a support structure. In at least one layer of the support structure, a contact layer in contact with the shaped object above or below the shaped object and a non-contact layer different from the contact layer are disposed adjacent to each other. The generating the shaping data includes a specifying step of specifying, based on shape data of the shaped object, a first region for shaping the contact layer and a second region for shaping the non-contact layer, as a support region, and a data generation step of generating the path data in the support region based on a path generation condition. In the data generation step, when a width of the specified first region is insufficient to generate the path data based on the path generation condition, the first region is expanded to the second region adjacent thereto to generate the path data in the first region.

The present application is based on, and claims priority from JP Application Serial Number 2022-190379, filed Nov. 29, 2022, the disclosure of which is hereby incorporated by reference herein in its entirety.

### BACKGROUND

### 1. Technical Field

The present disclosure relates to a three-dimensional shaped object manufacturing method and an information processing device.

### 2. Related Art

Regarding a three-dimensional shaped object manufacturing method, JP-T-2021-511990 discloses that a second layer structure is formed at a first layer structure and a support structure by extrusion deposition, and then the support structure is removed.

As described in JP-T-2021-511990, by forming a support structure that supports a shaped object, it is possible to prevent shape deformation of the shaped object and accurately shape the shaped object. Here, when forming the support structure as in JP-T-2021-511990, depending on a shape of the support structure and shaping conditions, a movement path of a nozzle for shaping the support structure cannot be set as intended, and as a result, a part of the support structure may be missing. When a part of the support structure is missing, the accuracy of the shaped object may be affected.

### SUMMARY

According to a first aspect of the present disclosure, there is provided a three-dimensional shaped object manufacturing method of manufacturing a three-dimensional shaped object by stacking layers. The three-dimensional shaped object manufacturing method includes: generating shaping data including path data representing a path along which a nozzle moves while ejecting a shaping material; and shaping, based on the shaping data, a shaped object and a support structure supporting the shaped object.

In at least one layer of the support structure, a contact layer in contact with the shaped object above or below the shaped object and a non-contact layer different from the contact layer are disposed adjacent to each other. The generating the shaping data includes a specifying step of specifying, based on data representing a shape of the shaped object, a first region for shaping the contact layer and a second region for shaping the non-contact layer, as a support region for shaping the support structure, and a data generation step of generating the path data in the support region based on a predetermined path generation condition. In the data generation step, when a width of the first region specified in the specifying step is insufficient to generate the path data based on the path generation condition, the first region is expanded to the second region adjacent to the first region such that the path data is generated in the first region.

According to a second aspect of the present disclosure, there is provided an information processing device that generates shaping data used in a three-dimensional shaping device for shaping a shaped object and a support structure supporting the shaped object by ejecting a shaping material to stack layers. The information processing device includes a data generation unit configured to generate path data included in the shaping data and representing a path along which a nozzle of the three-dimensional shaping device moves while ejecting the shaping material. The data generation unit is configured to execute specifying processing of specifying, based on data representing a shape of the shaped object, a first region for shaping a contact layer that is in contact with the shaped object above or below the shaped object and a second region for shaping a non-contact layer different from the contact layer, as a support region for shaping the support structure, and data generation processing of generating the path data in the support region based on a predetermined path generation condition. In at least one layer of the support structure, the contact layer and the non-contact layer are disposed adjacent to each other. In the data generation processing, when a width of the first region specified in the specifying processing is insufficient to generate the path data based on the path generation condition, the data generation unit expands the first region to the second region adjacent to the first region such that the path data is generated in the first region.

### BRIEF DESCRIPTION OF THE DRAWINGS

FIG. 1 is a diagram showing a schematic configuration of a three-dimensional shaping system.

FIG. 2 is a perspective view showing a schematic configuration of a lower surface side of a flat screw.

FIG. 3 is a schematic plan view showing an upper surface side of a barrel.

FIG. 4 is a diagram schematically showing a state in which a three-dimensional shaping device shapes a shaped object.

FIG. 5 is a diagram showing a schematic configuration of an information processing device.

FIG. 6 is a flowchart of shaping processing.

FIG. 7 is a flowchart of specifying processing.

FIG. 8A is a diagram showing an example of a shape of the shaped object.

FIG. 8B is a diagram showing an example of a shape of a support structure.

FIG. 9A is a first diagram showing the specifying processing.

FIG. 9B is a second diagram showing the specifying processing.

FIG. 10 is a flowchart of data generation processing according to a first embodiment.

FIG. 11A is a first diagram showing the data generation processing according to the first embodiment.

FIG. 11B is a second diagram showing the data generation processing according to the first embodiment.

FIG. 11C is a third diagram showing the data generation processing according to the first embodiment.

FIG. 12 is a diagram showing an example in which shaping data generated by a data generation unit is visualized.

FIG. 13 is a flowchart of data generation processing according to a second embodiment.

FIG. 14A is a first diagram showing the data generation processing according to the second embodiment.

FIG. 14B is a second diagram showing the data generation processing according to the second embodiment.

FIG. 14C is a third diagram showing the data generation processing according to the second embodiment.

### DESCRIPTION OF EMBODIMENTS

### A. First Embodiment

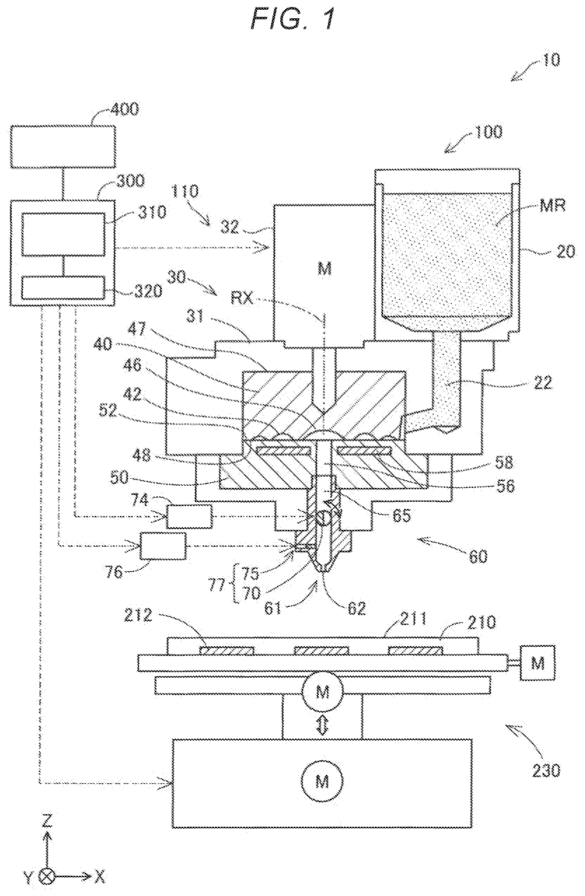

FIG. 1 is a diagram showing a schematic configuration of a three-dimensional shaping system 10 according to a first embodiment. In FIG. 1, arrows indicating X, Y, and Z directions orthogonal to one another are shown. The X direction and the Y direction are directions parallel to a horizontal plane, and the z direction is a direction along a vertically upward direction. The arrows indicating the X, Y, and Z directions are also shown in other drawings as appropriate such that the directions shown in the drawings correspond to those in FIG. 1. In the following description, when an orientation of a direction is specified, a direction indicated by an arrow in each drawing is referred to as “+”, a direction opposite therefrom is referred to as “−”, and a positive or negative sign is used in combination with a direction notation. Hereinafter, a +Z direction is also referred to as “upper”, and a −Z direction is also referred to as “lower”. A plane along the X direction and the Y direction is also referred to as an “XY plane”. A direction along the XY plane is also referred to as an XY direction.

The three-dimensional shaping system 10

includes a three-dimensional shaping device 100 and an information processing device 400. The three-dimensional shaping device 100 according to the embodiment is a device that shapes a shaped object by a material extrusion method. The three-dimensional shaping device 100 includes a control unit 300 that controls units of the three-dimensional shaping device 100. The control unit 300 and the information processing device 400 are communicably coupled to each other. Hereinafter, the shaped object is also referred to as a shaped object main body.

The three-dimensional shaping device 100 includes a shaping unit 110 that generates and ejects a shaping material, a shaping stage 210 serving as a base of a shaped object, and a movement mechanism 230 that controls an ejection position of the shaping material.

The shaping unit 110 ejects the shaping material obtained by plasticizing a material in a solid state onto the stage 210 under the control of the control unit 300. The shaping unit 110 includes a material supply unit 20 that is a supply source of a raw material before being converted into the shaping material, a plasticizing unit 30 that converts the raw material into the shaping material, and an ejection unit 60 that ejects the shaping material.

The material supply unit 20 supplies a raw material MR to the plasticizing unit 30. The material supply unit 20 is implemented by, for example, a hopper that accommodates the raw material MR. The material supply unit 20 is coupled to the plasticizing unit 30 via a communication path 22. The raw material MR is fed into the material supply unit 20 in a form of pellets, powder, or the like. In the embodiment, a pellet-shaped ABS resin material is used.

The plasticizing unit 30 plasticizes the raw material MR supplied from the material supply unit 20 to generate a paste-shaped shaping material exhibiting fluidity, and guides the shaping material to the ejection unit 60. In the embodiment, the term “plasticization” is a concept including melting, and is a change from a solid state to a fluid state. Specifically, in a case of a material in which glass transition occurs, the plasticization refers to setting a temperature of the material to be equal to or higher than a glass transition point. In a case of a material in which the glass transition does not occur, the plasticization refers to setting a temperature of the material to be equal to or higher than a melting point thereof.

The plasticizing unit 30 includes a screw case 31, a drive motor 32, a flat screw 40, and a barrel 50. The flat screw 40 is also referred to as a rotor or a scroll. The barrel 50 is also referred to as a screw facing portion.

The flat screw 40 is accommodated in the screw case 31. An upper surface 47 of the flat screw 40 is coupled to the drive motor 32, and the flat screw 40 is rotated in the screw case 31 by a rotational driving force generated by the drive motor 32. The drive motor 32 is driven under the control of the control unit 300. The flat screw 40 may be driven by the drive motor 32 via a speed reducer.

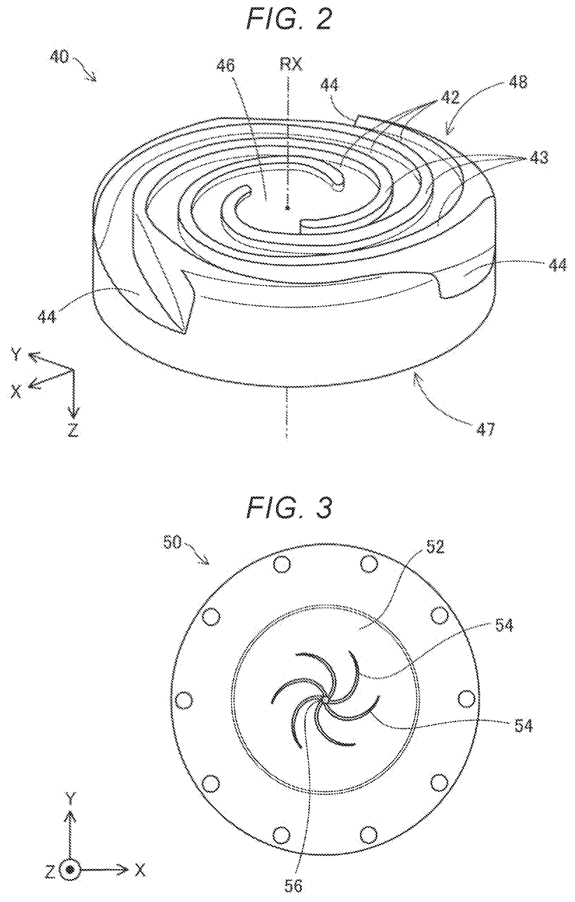

FIG. 2 is a perspective view showing a schematic configuration of a lower surface 48 of the flat screw 40. In order to facilitate understanding of the technique, the flat screw 40 shown in FIG. 2 is shown in a state in which a positional relationship between the upper surface 47 and the lower surface 48 shown in FIG. 1 is reversed in a vertical direction. The flat screw 40 has a substantially columnar shape in which a length in an axial direction which is a direction along a center axis of the flat screw 40 is smaller than a length in a direction orthogonal to the axial direction. The flat screw 40 is disposed such that a rotation axis RX serving as a rotation center of the flat screw 40 is parallel to the Z direction.

Spiral groove portions 42 are formed in the lower surface 48 of the flat screw 40 which is a surface intersecting with the rotation axis RX. The communication path 22 of the material supply unit 20 described above communicates with the groove portions 42 from a side surface of the flat screw 40. In the embodiment, three groove portions 42 are formed by being separated by ridge portions 43. The number of groove portions 42 is not limited to three, and may be one or two or more. A shape of the groove portion 42 is not limited to the spiral shape, and may be a helical shape or an involute curved shape, or may be a shape extending in a manner of drawing an arc from a center portion toward an outer periphery.

As shown in FIG. 1, the lower surface 48 of the flat screw 40 faces an upper surface 52 of the barrel 50, and a space is formed between the groove portions 42 of the lower surface 48 of the flat screw 40 and the upper surface 52 of the barrel 50. The raw material MR is supplied from the material supply unit 20 to the space between the flat screw 40 and the barrel 50 through material inlets 44 shown in FIG. 2.

A barrel heater 58 for heating the raw material MR supplied into the groove portions 42 of the rotating flat screw 40 is embedded in the barrel 50. A communication hole 56 is provided at a center of the barrel 50.

FIG. 3 is a schematic plan view showing the upper surface 52 of the barrel 50. A plurality of guide grooves 54 coupled to the communication hole 56 and extending in a spiral shape from the communication hole 56 toward the outer periphery are formed in the upper surface 52 of the barrel 50. One end of the guide groove 54 may not be coupled to the communication hole 56. The guide groove 54 may be omitted.

The raw material MR supplied into the groove portions 42 of the flat screw 40 flows along the groove portions 42 by the rotation of the flat screw 40 while being plasticized in the groove portions 42, and is guided to a center portion 46 of the flat screw 40 as the shaping material. The paste-shaped shaping material that flows into the center portion 46 and that exhibits fluidity is supplied to the ejection unit 60 via the communication hole 56 provided at the center of the barrel 50. In the shaping material, not all types of substances constituting the shaping material have to be plasticized. The shaping material may be converted into a state having fluidity as a whole by plasticizing at least a part of types of substances among the substances constituting the shaping material.

The ejection unit 60 in FIG. 1 includes a nozzle 61 that ejects the shaping material, a flow path 65 of the shaping material provided between the flat screw 40 and a nozzle opening 62, and an ejection control unit 77 that controls the ejection of the shaping material.

The nozzle 61 is coupled to the communication hole 56 of the barrel 50 through the flow path 65. The nozzle 61 ejects, from the nozzle opening 62 at a tip end thereof, the shaping material generated in the plasticizing unit 30 toward the stage 210.

The ejection control unit 77 includes an ejection adjustment unit 70 that opens and blocks the flow path 65, and a suction unit 75 that sucks and temporarily stores the shaping material.

The ejection adjustment unit 70 is provided in the flow path 65, and changes an opening degree of the flow path 65 by being rotated in the flow path 65. In the embodiment, the ejection adjustment unit 70 is implemented by a butterfly valve. The ejection adjustment unit 70 is driven by a first drive unit 74 under the control of the control unit 300. The first drive unit 74 is implemented by, for example, a stepping motor. The control unit 300 uses the first drive unit 74 to control a rotation angle of the butterfly valve, so that a flow rate of the shaping material flowing from the plasticizing unit 30 to the nozzle 61, that is, an ejection amount of the shaping material ejected from the nozzle 61 can be adjusted. The ejection adjustment unit 70 can adjust the ejection amount of the shaping material and can control ON/OFF of outflow of the shaping material.

The suction unit 75 is coupled between the ejection adjustment unit 70 in the flow path 65 and the nozzle opening 62. The suction unit 75 temporarily sucks the shaping material in the flow path 65 when the ejection of the shaping material from the nozzle 61 is stopped, thereby preventing a tailing phenomenon in which the shaping material drips from the nozzle opening 62 in a form of a thread. In the embodiment, the suction unit 75 includes a plunger. The suction unit 75 is driven by a second drive unit 76 under the control of the control unit 300. The second drive unit 76 is implemented by, for example, a stepping motor, or a rack-and-pinion mechanism that converts a rotational force of the stepping motor into a translational motion of the plunger.

The stage 210 is disposed at a position facing the nozzle opening 62 of the nozzle 61. In the first embodiment, a shaping surface 211 of the stage 210 facing the nozzle opening 62 of the nozzle 61 is parallel to the X and Y directions, that is, a horizontal direction. The stage 210 is provided with a stage heater 212 for preventing rapid cooling of the shaping material ejected onto the stage 210. The stage heater 212 is controlled by the control unit 300.

The movement mechanism 230 changes a relative position between the stage 210 and the nozzle 61 under the control of the control unit 300. In the embodiment, a position of the nozzle 61 is fixed, and the movement mechanism 230 moves the stage 210. The movement mechanism 230 is implemented by a three-axis positioner that moves the stage 210 in three-axial directions including the X, Y, and Z directions by driving forces of three motors. In the present specification, unless otherwise specified, movement of the nozzle 61 means moving the nozzle 61 or the ejection unit 60 with respect to the stage 210.

In another embodiment, instead of the configuration in which the stage 210 is moved by the movement mechanism 230, a configuration may be adopted in which the movement mechanism 230 moves the nozzle 61 with respect to the stage 210 in a state in which a position of the stage 210 is fixed. A configuration in which the movement mechanism 230 moves the stage 210 in the Z direction and moves the nozzle 61 in the X and Y directions, or a configuration in which the movement mechanism 230 moves the stage 210 in the X and Y directions and moves the nozzle 61 in the Z direction may be adopted. With these configurations, a relative positional relationship between the nozzle 61 and the stage 210 can be changed.

The control unit 300 is a control device that controls an overall operation of the three-dimensional shaping device 100. The control unit 300 is implemented by a computer including one or a plurality of processors 310, a storage device 320 including a main storage device and an auxiliary storage device, and an input and output interface that receives and outputs a signal from and to the outside. By executing a program stored in the storage device 320, the processor 310 controls the shaping unit 110 and the movement mechanism 230 according to shaping data acquired from the information processing device 400 to shape a shaped object on the stage 210. Instead of being implemented by the computer, the control unit 300 may be implemented by a configuration in which circuits are combined.

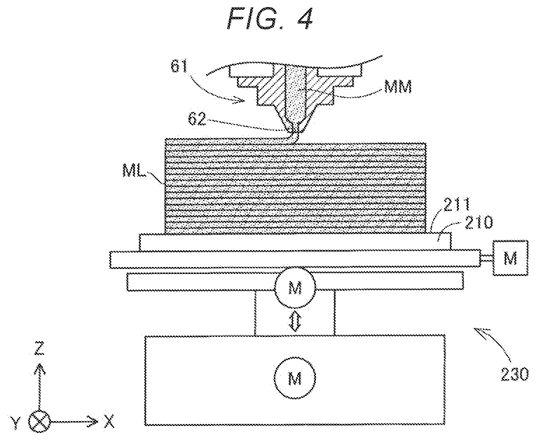

FIG. 4 is a diagram schematically showing a state in which the three-dimensional shaping device 100 shapes the shaped object. In the three-dimensional shaping device 100, as described above, the raw material MR in the solid state is plasticized and a shaping material MM is generated. The control unit 300 keeps a distance between the shaping surface 211 of the stage 210 and the nozzle 61, and ejects the shaping material MM from the nozzle 61 while changing the position of the nozzle 61 with respect to the stage 210 in a direction along the shaping surface 211 of the stage 210. The shaping material MM ejected from the nozzle 61 is continuously deposited in a moving direction of the nozzle 61.

The control unit 300 forms a layer ML by repeating the movement of the nozzle 61. After one layer ML is formed, the control unit 300 relatively moves the position of the nozzle 61 with respect to the stage 210 in the Z direction. Then, a layer ML is further laminated on the layer ML formed so far to shape the shaped object.

For example, the control unit 300 may temporarily interrupt the ejection of the shaping material from the nozzle 61 when the nozzle 61 is moved in the Z direction after one layer ML is completely formed or when there are a plurality of independent shaping regions in each layer. In this case, the flow path 65 is blocked by the ejection adjustment unit 70, the ejection of the shaping material MM from the nozzle opening 62 is stopped, and the shaping material in the nozzle 61 is temporarily sucked by the suction unit 75. After changing the position of the nozzle 61, the control unit 300 causes the ejection adjustment unit 70 to open the flow path 65 while discharging the shaping material in the suction unit 75, thereby resuming the deposition of the shaping material MM from the position of the nozzle 61 after change.

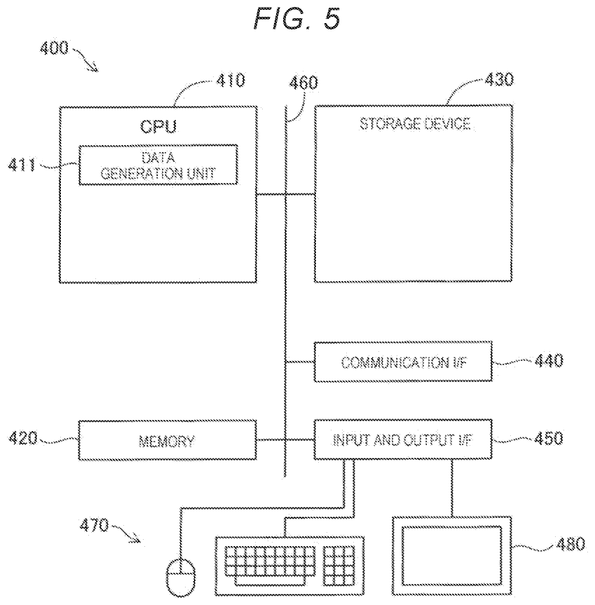

FIG. 5 is a diagram showing a schematic configuration of the information processing device 400. The information processing device 400 is implemented by a computer in which a CPU 410, a memory 420, a storage device 430, a communication interface 440, and an input and output interface 450 are coupled to one another by a bus 460. An input device 470 such as a keyboard and a mouse and a display device 480 such as a liquid crystal display are coupled to the input and output interface 450. The information processing device 400 is coupled to the control unit 300 of the three-dimensional shaping device 100 via the communication interface 440.

The CPU 410 functions as a data generation unit 411 by executing a program stored in the storage device 430. The data generation unit 411 executes specifying processing and data generation processing.

The specifying processing refers to processing of specifying, based on shape data representing a shape of the shaped object, a support region for shaping a support structure supporting the shaped object. More specifically, in the specifying processing, the data generation unit 411 specifies a first region for shaping a contact layer and a second region for shaping a non-contact layer as the support region. The contact layer and the non-contact layer are layers constituting a part or an entire of a layer of the support structure in the XY direction. The contact layer is a portion of the layer of the support structure that is in contact with the shaped object in a stacking direction, and more specifically, a portion that is in contact with the shaped object above or below the shaped object. The contact layer may be in contact with the shaped object both above and below the shaped object. The non-contact layer is a portion different from the contact layer in the layer of the support structure. That is, the non-contact layer is not in contact with the shaped object above and below the shaped object. The layers of the support structure may be layers including both the contact layer and the non-contact layer, or may be a layer including only one of the contact layer and the non-contact layer. Hereinafter, the layers of the support structure are also referred to as support layers. The support layer having only one of the contact layer and the non-contact layer is also referred to as a single layer. The layer of the shaped object main body is also referred to as a main body layer.

The data generation processing refers to processing of generating path data in the support region based on a predetermined path generation condition. The path data is data representing a path along which the nozzle 61 moves while ejecting the shaping material. The path generation condition is a condition for generating a path in the support region. In the embodiment, the data generation unit 411 can apply different path generation conditions in a case of generating path data in the first region and a case of generating path data in the second region. Details of the path generation condition will be described later. Hereinafter, the path data generated in the support region is also referred to as support path data. The data for shaping the support structure is also referred to as support data. The support path data is included in the support data.

In the embodiment, the data generation unit 411 generates main body data for shaping the shaped object main body as to be described later. The main body data includes main body path data. The main body path data represents path data generated in a main body region for shaping the shaped object main body.

The information processing device 400 transmits shaping data including the main body data and the support data generated by the data generation unit 411 to the control unit 300 of the three-dimensional shaping device 100. The control unit 300 controls the ejection unit 60 and the movement mechanism 230 according to the received shaping data to eject the material and stack a layer in the stacking direction, thereby shaping, on the stage 210, the shaped object and the support structure that supports the shaped object.

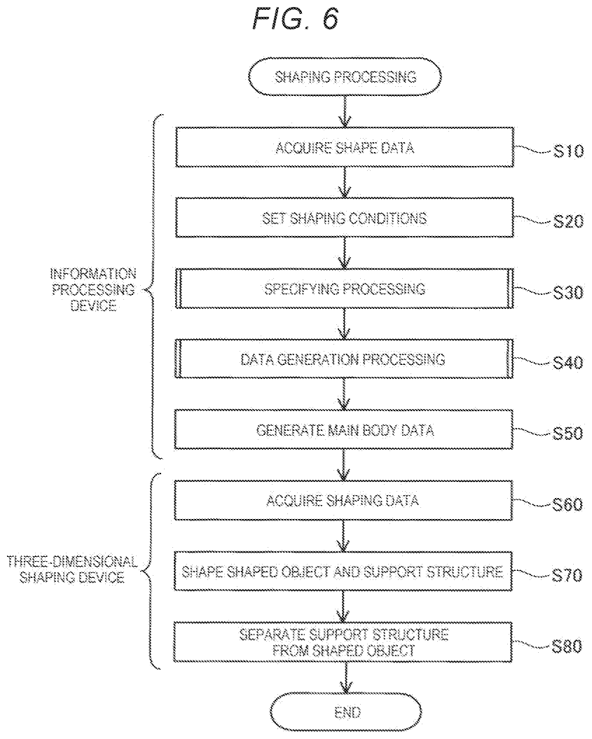

FIG. 6 is a flowchart of shaping processing executed in the three-dimensional shaping system 10. The shaping processing is processing of implementing a three-dimensional shaped object manufacturing method. The shaping processing is executed, for example, when a predetermined start operation is performed by a user on the control unit 300. The processing of steps S10 to S50 shown in FIG. 6 is executed in the information processing device 400, and the processing of steps S60 to S80 is executed in the three-dimensional shaping device 100.

In step S10, the data generation unit 411 of the information processing device 400 acquires shape data from another computer, a recording medium, or the storage device 430. In step S10, the data generation unit 411 acquires, as the shape data, three-dimensional shape data created using three-dimensional CAD software, three-dimensional CG software, or the like. In this case, for example, data in an STL format or an AMF format can be used as the shape data. The shape data may be data representing the shape of the shaped object, and may be, for example, main body data and shaping data generated by another three-dimensional shaping device or another information processing device. In this case, the data generation unit 411 may acquire the shape of the shaped object by analyzing the main body data and the shaping data.

In step S20, the data generation unit 411 receives settings of shaping conditions related to the support structure from the user. The user operates a setting screen displayed on the display device 480 using the input device 470 shown in FIG. 5 to set the shaping conditions.

In the embodiment, different shaping conditions can be set for the first region and the second region described above. More specifically, as the shaping conditions, a line width, a stacking pitch, the number of layers, a shaping pattern, a filling rate, the number of rounds, and a separation distance are individually set for the first region and the second region. In step S20, for example, the user sets the shaping conditions by inputting a numerical value for each item. In another embodiment, some or all of the above items may not be set by the user, and may be determined by the data generation unit 411 or the control unit 300 without depending on the user.

The “line width” is an item representing a width of the shaping material ejected from the nozzle 61. The “stacking pitch” is an item representing a height of each layer. “The number of layers” is an item representing the number of the contact layers or the non-contact layers. The “shaping pattern” is an item representing a pattern indicating a movement path of the nozzle 61 for filling internal regions of the contact layer or the non-contact layer. The “filling rate” is an item representing an area ratio in which the internal regions are filled with the designated shaping pattern. “The number of rounds” is an item representing the number of rounds for forming a contour of the contact layer or the non-contact layer. The “separation distance” is an item representing a distance by which the nozzle 61 is separated from a top layer that is shaped during shaping. Therefore, no gap is formed in an actual shaped object, and the shaping material is ejected from above by a designated distance. The separation distance is not limited to an actual dimension, and may be designated by the number of layers.

In the embodiment, it is possible to set “the number of rounds” to one or more, and the path data is generated in one support region such that the contour is formed by moving at least one round in the support region. “The number of rounds” set as the shaping condition can also be said to determine a minimum number of paths disposed in a line width direction in one support region. More specifically, when the set number of rounds is one or more, the “minimum number of paths” is twice the number of rounds. For example, when the number of rounds is set to one, the minimum number of paths is two. When the number of rounds is set to two, the minimum number of paths is four. In another embodiment, for example, the minimum number of paths may be directly settable as the shaping condition. Hereinafter, the minimum number of paths is also simply referred to as the “minimum number”.

In step S20, in order to make it easier to peel off a contact layer CP from a shaped object MD in step S80 to be described later, for example, in the contact layer CP, the shaping conditions for a first region SA1 can be set such that, in comparison with a non-contact layer nCP, the stacking pitch is increased, a shaping pattern that is easier to peel off from the shaped object MD is used, the filling rate decreases, and the separation distance increases. When the contact layer CP is shaped, by increasing the stacking pitch and the separation distance, the upper surface of the material for shaping the contact layer CP ejected from the nozzle 61 is less likely to be pressed by a lower end surface of the nozzle 61. Therefore, an adhesion strength between the contact layer CP and the shaped object MD can be reduced, and the contact layer CP can be easily peeled off from the shaped object MD.

The data generation unit 411 generates the shaping data by executing steps S30 to S50 in FIG. 6. The step of generating the shaping data as in step S30 to step S50 in the embodiment is also referred to as a first step.

In the first step, the data generation unit 411 first specifies the first region and the second region based on the shape data by executing the specifying processing shown in step S30 of FIG. 6. The step of specifying the first region and the second region based on the shape data as in step S30 is also referred to as a specifying step.

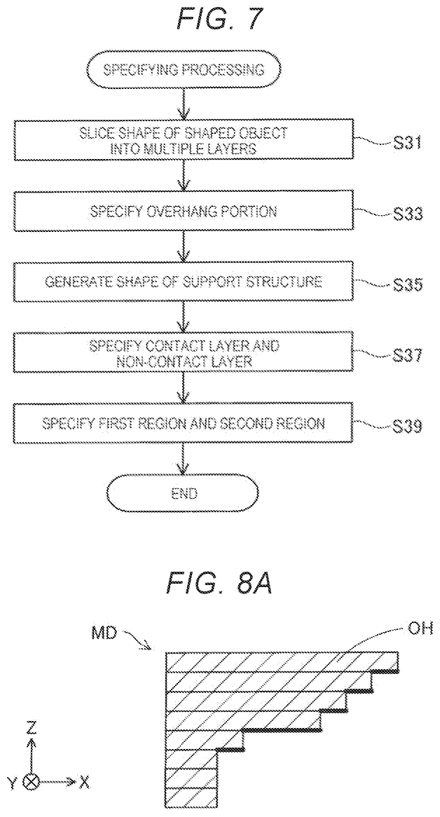

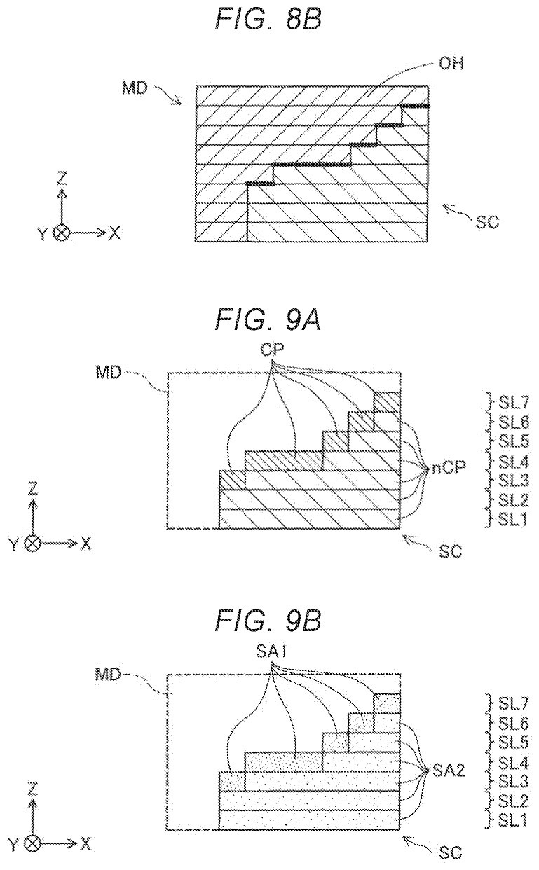

FIG. 7 is a flowchart of the specifying processing executed in step S30 of FIG. 6. FIG. 8A is a diagram showing an example of a shape of the shaped object MD. FIG. 8A shows an example of the shape of the shaped object MD represented by the shape data. In FIG. 8A, the shape of the shaped object MD is indicated by hatching with lines upward to the right.

In step S31 of FIG. 7, the data generation unit 411 analyzes the shape data acquired in step S10 of FIG. 6, and slices the shape of the shaped object MD into a plurality of layers along the XY plane according to the stacking pitch and the number of layers included in the shaping conditions. FIG. 8A shows a state in which the shape of the shaped object MD is sliced in this manner.

In step S33 of FIG. 7, the data generation unit 411 specifies an overhang portion OH of the shaped object MD. The overhang portion OH refers to a projection portion of the shaped object MD which is not supported below. The meaning of the “overhang portion OH” includes a bridge portion. The bridge portion refers to a bridge-shaped portion of the shaped object whose both ends are supported. The overhang portion OH shown in FIG. 8A is a simple overhang portion OH which is not a bridge portion. In FIG. 8A, a lower surface of the overhang portion OH is represented by a thick line.

In step S35 of FIG. 7, the data generation unit 411 generates a shape of the support structure.

FIG. 8B is a diagram showing an example of a shape of a support structure SC generated in step S35. In FIG. 8B, the shape of the support structure SC is indicated by hatching with lines downward to the right. In FIG. 8B, similarly to FIG. 8A, the shape of the shaped object MD is indicated by hatching with lines upward to the right, and the lower surface of the overhang portion OH is represented by the thick line.

In the embodiment, in step S35 of FIG. 7, as shown in FIG. 8B, the data generation unit 411 generates the shape of the support structure SC such that the entire lower surface of the overhang portion OH is supported by the support structure SC from below and the support structure SC is covered with the overhang portion OH when viewed from above in the stacking direction. The shape of the support structure SC is sliced into a plurality of layers according to the stacking pitch and the number of layers in substantially the same manner as the shape of the shaped object MD. Hereinafter, each support layer generated by slicing the shape of the support structure SC is also referred to as an n-th support layer using a natural number n in order of closeness from the stage 210 in the Z direction. For example, a second support layer is the second support layer counted from the bottom.

FIG. 9A is a first diagram showing the specifying processing. FIG. 9B is a second diagram showing the specifying processing. In FIG. 9A, similarly to FIG. 8B, the support structure SC is indicated by hatching with lines downward to the right. In FIGS. 9A and 9B, the shaped object MD is indicated by a broken line. In FIG. 9A, the contact layers CP of the support structure SC are indicated by hatching darker than that of the non-contact layers nCP. Each contact layer CP shown in FIG. 9A is in contact with the shaped object MD below the shaped object MD. In step S37 of FIG. 7, as shown in FIG. 9A, the data generation unit 411 specifies the contact layer CP and the non-contact layer nCP for each of all the layers of the support structure SC generated in step S35.

As shown in FIG. 9A, in at least one layer of the support structure SC, the contact layer CP and the non-contact layer nCP are disposed adjacent to each other. The expression “the contact layer CP and the non-contact layer nCP are . . . adjacent to each other” means that the contact layer CP and the non-contact layer nCP are adjacent to each other in a direction along the XY plane. As shown in FIG. 9A, in the embodiment, each of a third support layer SL3 to a sixth support layer SL6 includes the contact layer CP and the non-contact layer nCP adjacent to each other. Each of a first support layer SL1 and a second support layer SL2 is a single layer having only the non-contact layer nCP. A seventh support layer SL7 is a single layer having only the contact layer CP.

In step S39 of FIG. 7, as shown in FIG. 9B, the data generation unit 411 specifies the first region SA1 as a region for shaping the contact layer CP specified in step S37, and specifies a second region SA2 as a region for shaping the non-contact layer nCP specified in the same manner. In FIG. 9B, the support region, that is, the first regions SA1 and the second regions SA2 are indicated by hatching with a shaded pattern. In FIG. 9B, the first region SA1 is indicated by hatching darker than that of the second region SA2. In step S39 of the embodiment, the data generation unit 411 specifies the main body region in addition to the first region SA1 and the second region SA2.

Next, the data generation unit 411 generates the support path data based on the path generation condition by executing the data generation processing in step S40 of FIG. 6. As in step S40, the step of generating the support path data based on the path generation condition is also referred to as a data generation step.

More specifically, in the embodiment, the data generation unit 411 generates support data including the support path data and ejection amount information in the data generation processing of step S40. In the embodiment, the data generation unit 411 generates the support path data using the line width, the shaping pattern, the filling rate, and the minimum number of paths determined in step S20 of FIG. 6 as the path generation condition when generating the support data. Each path included in the support path data includes the ejection amount information representing an ejection amount of the shaping material ejected in the path. The data generation unit 411 generates the support data including the support path data and the ejection amount information by executing the generation of the support path data including the ejection amount information for each support layer. The support data is represented by, for example, a G code.

In the data generation processing, when a width of the first region SA1 specified in the specifying processing is insufficient to generate the path data based on the path generation condition, the data generation unit 411 expands the first region SA1 to the adjacent second region SA2 in the same layer such that the path data is generated in the first region SA1. The width of the first region SA1 or the second region SA2 refers to a minimum width of the region in the XY direction. In the present specification, the expression “the width of the first region SA1 is insufficient” indicates that the width of the first region SA1 is less than a total width of the minimum number of paths. Therefore, when a width of a certain first region SA1 is less than a product of the line width and the minimum number, the width of the first region SA1 is insufficient to generate the path data based on the path generation condition. Hereinafter, the first region SA1 whose width is insufficient is also referred to as a “narrow first region”. The first region expanded in the data generation processing is referred to as an expanded region. In the expanded region, a portion that is additionally generated as the first region SA1 expands is referred to as an added region. Accordingly, the expanded region includes the first region SA1 specified in the specifying processing and the added region. When the first region SA1 is expanded to the second region SA2 as described above, the added region corresponds to a portion that is originally the second region SA2.

Similarly to the case of the first region SA1, in the present specification, “the width of the second region SA2 is insufficient” means that the width of the second region SA2 is less than the total width of the minimum number of paths. Hereinafter, the second region SA2 whose width is insufficient to generate the path data based on the path generation condition is also referred to as a narrow second region.

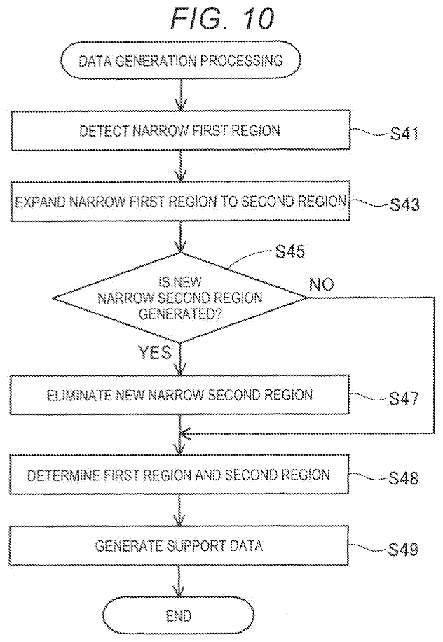

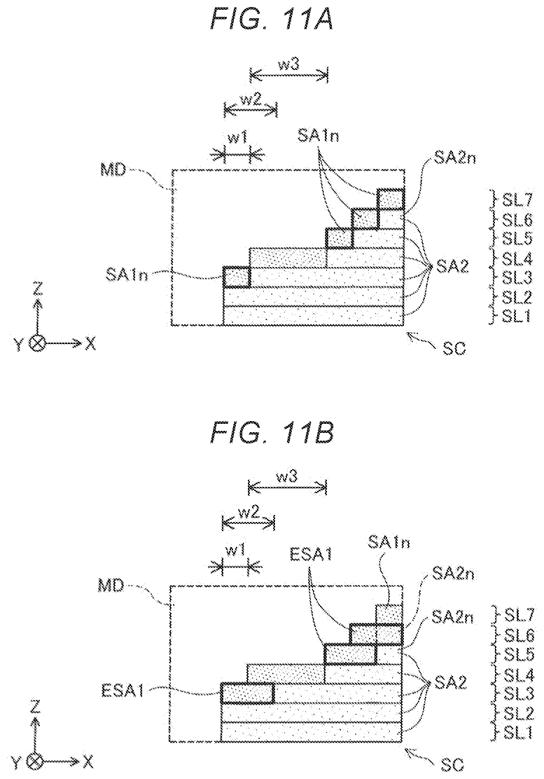

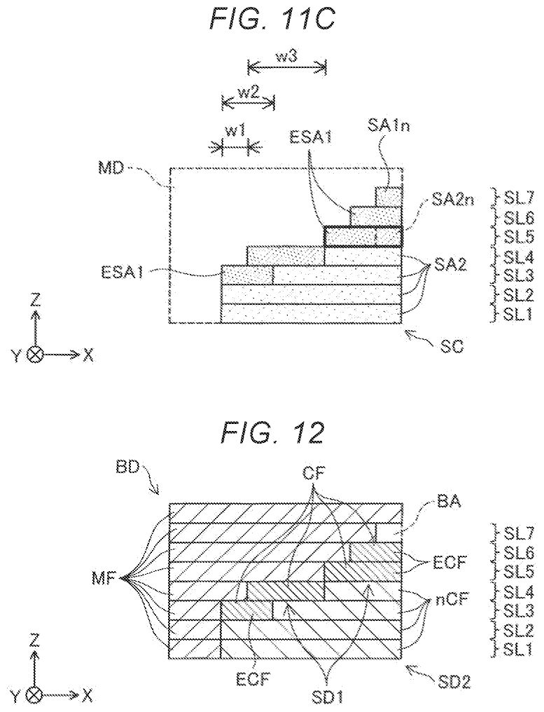

FIG. 10 is a flowchart of the data generation processing. FIG. 11A is a first diagram showing the data generation processing. FIG. 11B is a second diagram showing the data generation processing. FIG. 11C is a third diagram showing the data generation processing. In FIGS. 11A to 11C, the first region SA1 and the second region SA2 are indicated by hatching similarly to FIG. 9B. FIGS. 11A to 11C illustrate an example of the data generation processing when “the number of rounds” is set to one for the first region SA1 and the second region SA2 in step S20 of FIG. 6. That is, in the example of FIGS. 11A to 11C, the support path data is generated in each support region such that the minimum number of paths is two.

In step S41 of FIG. 10, the data generation unit 411 detects a narrow first region SA1n for each support layer based on the path generation condition. In FIG. 11A, each of the narrow first regions SA1n is surrounded by a thick line. In FIG. 11A, a width w1 of each of the first regions SA1 in the third support layer SL3, the fifth support layer SL5, the sixth support layer SL6, and the seventh support layer SL7 corresponds to the line width of one path, and is narrower than a width w2 of two paths, that is, the total width of the minimum number of paths. Therefore, the first region SA1 in each support layer is detected as the narrow first region SA1n. As described above, in the embodiment, the line width and the minimum number in the path generation condition are used for detecting the narrow first region SA1n.

In FIG. 11A, the second region SA2 included in the sixth support layer SL6 has the width w1 and corresponds to a narrow second region SA2n. In another embodiment, in the data generation step, the data generation unit 411 may detect the narrow second region SA2n, for example, substantially similarly to step S41.

In step S43 of FIG. 10, the data generation unit 411 generates an expanded region ESA1 by expanding the narrow first region SA1n detected in step S41 to the second region SA2 adjacent to the narrow first region SA1n. FIG. 11B shows a state in which the expanded region ESA1 is generated in the third support layer SL3, the fifth support layer SL5, and the sixth support layer SL6. In FIG. 11B, the expanded region ESA1 generated in step S43 is indicated by a thick line. In the embodiment, the data generation unit 411 expands each narrow first region SA1n by a minimum width such that the path data can be generated in each expanded region ESA1. That is, the data generation unit 411 expands each narrow first region SA1n by the width w1. Therefore, the width of each expanded region ESA1 shown in FIG. 11B is the width w2. In step S49 to be described later, in a portion of the support region having the width w2 that is the minimum width for generating the path data, the path data for shaping the internal region is not generated, and only the path data for shaping the contour is generated.

In the embodiment, in the data generation step, the data generation unit 411 expands the narrow first region SA1n in the first region SA1 specified in the specifying step to the second region SA2, but does not expand the first region SA1 whose width is sufficient to generate the path data based on the path generation condition. That is, in the embodiment, the data generation unit 411 selectively expands only the narrow first region SA1n in the first region SA1 specified in the specifying step to the second region SA2. Hereinafter, the first region SA1 whose width is sufficient to generate the path data as described above is also referred to as a “wide first region SA1”. In the embodiment, the first region SA1 in the fourth support layer SL4 has a width w3 wider than the width w2, and corresponds to the wide first region SA1.

In the embodiment, since the seventh support layer SL7 is a single layer having only the contact layer CP, the narrow first region SA1n in the seventh support layer SL7 is not adjacent to the second region SA2. In the data generation processing according to the embodiment, the narrow first region SA1n in the layer having only the contact layer CP as described above is not expanded. Hereinafter, the first region SAL or the second region SA2 for shaping a single layer is also referred to as a single region. The narrow first region SA1n in the single layer is also referred to as a “single narrow first region SA1n”, and the narrow second region SA2n in the single layer is also referred to as a “single narrow second region SA2n”.

In FIG. 11B, the narrow second region SA2n included in the sixth support layer SL6 in FIG. 11A is overwritten by an added region of the expanded region ESA1 and is eliminated. In FIG. 11B, the narrow second region SA2n which is eliminated as described above is indicated by a broken line. That is, in the example of the data generation processing shown in FIGS. 11A to 11C, the narrow second region SA2n specified in the specifying processing is eliminated as the narrow first region SA1n adjacent to the narrow second region SA2n is expanded. More specifically, as the narrow first region SA1n in the sixth support layer SL6 shown in FIG. 11A is expanded to the entire narrow second region SA2n in the same layer, the narrow second region SA2n is eliminated.

In step S45 of FIG. 10, the data generation unit 411 determines whether a new narrow second region SA2n is generated in each support layer. The new narrow second region SA2n refers to a narrow second region SA2n which is newly generated as the second region SA2 is reduced due to the expansion of the narrow first region SA1n. In FIG. 11B, a new narrow second region SA2n having the width w1 is generated in the fifth support layer SL5.

When it is determined in step S45 of FIG. 10 that a new narrow second region SA2n is included in any of the support layers, the data generation unit 411 causes the processing to proceed to step S47. In step S47, as shown in FIG. 11C, the data generation unit 411 further expands the expanded region ESA1 to eliminate the new narrow second region SA2n detected in step S45. That is, in the embodiment, when the second region SA2 reduced by the generation of the expanded region ESA1 is the narrow second region SA2n, the data generation unit 411 further expands the expanded region ESA1 to eliminate the second region SA2. More specifically, in the example of the data generation processing shown in FIGS. 11A to 11C, the narrow second region SA2n is eliminated as the expanded region ESA1 in the fifth support layer SL5 is further expanded to the entire narrow second region SA2n in the fifth support layer SL5. In FIG. 11C, the narrow second region SA2n which is eliminated due to the further expansion of the expanded region ESA1 is indicated by a broken line. In FIG. 11C, the expanded region ESA1 further expanded in step S47 is indicated by a thick line.

In step S48, the data generation unit 411 determines the first region SA1 and the second region SA2. In the embodiment, the first region SA1 and the second region SA2 indicated by solid lines in FIG. 11C correspond to the first region SA1 and the second region SA2 determined in step S48.

As described in steps S41 to S48, in the data generation processing according to the embodiment, the expansion of the first region SA1 is performed within the support region specified in the specifying processing. In the data generation processing according to the embodiment, the expansion of the second region SA2 is not executed. That is, in the embodiment, when expanding the first region SA1 in the data generation step, the data generation unit 411 does not expand the first region SA1 and the second region SA2 to an outside of the support region specified in the specifying processing. Hereinafter, the support region specified in the specifying processing is also referred to as an initial support region.

In step S49, the data generation unit 411 generates the support data. More specifically, in step S49, the data generation unit 411 generates the support path data including the ejection amount information in the support region determined in step S48.

In step S50 of FIG. 6, the data generation unit 411 generates the main body data which is shaping data for shaping the shaped object main body. In the generation of the main body data, the data generation unit 411 generates, in the main body region, the main body path data representing the path of the nozzle 61 for forming the contour of each layer of the shaped object MD and filling the internal region thereof with a predetermined filling rate and shaping pattern. The main body path data includes data representing a plurality of linear paths. Each path included in the main body path data includes the ejection amount information representing the ejection amount of the shaping material ejected in the path. The data generation unit 411 generates the main body data by generating the main body path data and the ejection amount information for all the layers of the shaped object MD. The main body data is represented by the G code, for example, similarly to the support data. In the embodiment, the shaping data including the support data and the main body data is generated by completing step S40 and step S50.

FIG. 12 is a diagram showing an example in which the shaping data generated by the data generation unit 411 is visualized. The shaping data shown in FIG. 12 includes main body data BD, first support data SD1, and second support data SD2. The first support data SD1 is shaping data for shaping a contact layer in the determined first region SA1. The second support data SD2 is shaping data for shaping a non-contact layer in the determined second region SA2. FIG. 12 shows a shape MF of a main body layer shaped according to the main body data BD, a shape CF of a contact layer shaped according to the first support data SD1, and a shape nCF of a non-contact layer shaped according to the second support data SD2. In FIG. 12, the shape MF of the main body layer is indicated by hatching with lines upward to the right. In FIG. 12, the shape CF of the contact layer and the shape nCF of the non-contact layer are indicated by hatching with lines downward to the right, and the shape CF of the contact layer is indicated by hatching darker than the shape nCF of the non-contact layer.

As shown in FIG. 12, in the shape CF of the contact layer, a shape ECF of a contact layer shaped in the expanded region ESA1 includes a portion corresponding to the added region and a portion not in contact with the shape MF of the shaped object in the stacking direction. That is, the contact layer shaped in the expanded region ESA1 includes a portion not in contact with the shaped object MD in the stacking direction. In the present specification, the contact layer shaped in the expanded region ESA1 is simply referred to as a contact layer including a portion not in contact with the shaped object MD in the stacking direction. A portion of the contact layer corresponding to the added region is also referred to as an added portion.

In the example of FIG. 12, a region corresponding to the seventh support layer SL7 including only the narrow first region SA1n at a time point when the support region is determined is a blank region BA in which the support path data is not generated. Therefore, in the second step described later, neither the contact layer nor the non-contact layer is shaped in the region corresponding to the seventh support layer SL7. As described above, when the determined first region SA1 and second region SA2 are the narrow first region SA1n and the narrow second region SA2n, the support path data is not generated in the first region SA1 and the second region SA2.

In step S60 of FIG. 6, the control unit 300 of the three-dimensional shaping device 100 acquires the shaping data generated by the information processing device 400 from the information processing device 400.

In step S70, the control unit 300 shapes, based on the shaping data acquired from the information processing device 400, the shaped object MD and the support structure SC on the shaping surface 211 of the stage 210 by controlling the ejection unit 60 and the movement mechanism 230. The step of shaping the shaped object MD and the support structure SC based on the shaping data as in step S70 is also referred to as the second step.

In step S80, the support structure is separated from the shaped object. The support structure may be cut by a cutting device provided in the three-dimensional shaping device 100.

According to the three-dimensional shaped object manufacturing method in the embodiment described above, the first step of generating the shaping data includes the specifying step of specifying the first region SA1 and the second region SA2 as the support region based on the shape data, and the data generation step of generating the path data in the support region based on the path generation condition. In the data generation step, when the width of the first region SA1 specified in the specifying step is insufficient to generate the path data based on the path generation condition, the first region SA1 is expanded to the adjacent second region SA2 such that the path data is generated in the first region SA1. Therefore, even when the width of the first region SA1 specified in the specifying step is insufficient to generate the path data, the path data can be generated in the first region SA1 by expanding the first region SA1 to the second region SA2. Accordingly, it is possible to prevent missing of the contact layer CP in the support structure SC due to the fact that the path data is not generated in the first region SA1. Since the contact layer CP is a portion that is directly in contact with the shaped object MD above or below the shaped object MD, it is possible to effectively prevent the influence on the accuracy of the shaped object MD by preventing the missing of the contact layer CP in this manner.

In the embodiment, when the width of the second region SA2 reduced by expanding the first region SA1 is insufficient to generate the path data based on the path generation condition, the second region SA2 is eliminated by further expanding the expanded first region SA1. That is, when a new narrow second region SA2n is generated by generating the expanded region ESA1, the new narrow second region SA2n is eliminated by further expanding the expanded region ESA1. Therefore, it is possible to prevent partial missing of the support structure SC due to the fact that the path data is not generated in the new narrow second region SA2n. In this case, it is possible to prevent a portion of the support structure SC that is not in contact with the shaped object MD in the stacking direction from being lost, and in addition, it is easy to stably shape a layer of the support structure above the portion by preventing the missing of the portion.

In the embodiment, in the data generation step, when the width of the second region SA2 specified in the specifying step is insufficient to generate the path data based on the path generation condition, the second region SA2 is eliminated by expanding the first region SA1. Therefore, it is possible to prevent partial missing of the support structure SC due to the fact that the path data is not generated in the narrow second region SA2n specified in the specifying step. In this case, it is possible to prevent a portion of the support structure SC that is not in contact with the shaped object MD in the stacking direction from being lost, and in addition, it is easy to stably shape a layer of the support structure above the portion by preventing the missing of the portion.

In the embodiment, in the data generation step, the narrow first region SA1n of a plurality of the first regions SA1 specified in the specifying step is expanded to the second region SA2, and the wide first region SA1 is not expanded. In this way, only the narrow first region SA1n can be selectively expanded to the second region SA2. Therefore, for example, a data processing speed in the data generation step can be improved as compared with an aspect in which the wide first region SA is also expanded.

In the embodiment, in the data generation step, when the first region SA1 is expanded, the first region SA1 and the second region SA2 are not expanded to the outside of the initial support region. Therefore, a time and a material required for shaping the support structure SC can be reduced as compared with an aspect in which the first region SA1 and the second region SA2 are expanded to the outside of the initial support region. Since the contact layer CP and the non-contact layer nCP are shaped in the initial support region, it is possible to prevent the contact layer CP and the non-contact layer nCP from unintentionally coming into contact with the shaped object MD. For example, it is possible to prevent a side surface of the contact layer CP and a side surface of the non-contact layer nCP from unintentionally coming into contact with a side surface of the shaped object MD. Unlike the embodiment, for example, in an aspect in which the entire support region is uniformly expanded such that the path data is generated in the narrow first region SA1n, the first region SA1 and the second region SA2 are naturally expanded to the outside of the initial support region. On the other hand, in the embodiment, since the narrow first region SA1n is expanded to the second region SA2, as described above, it is possible not to expand the first region SA1 and the second region SA2 to the outside of the initial support region.

In the embodiment, as described above, in step S35 of FIG. 7, the shape of the support structure SC is generated such that the support structure SC is covered with the overhang portion OH when viewed from above in the stacking direction. Therefore, by not expanding the first region SA1 and the second region SA2 to the outside of the initial support region in the data generation step, the support structure SC is shaped to be covered with the shaped object MD when viewed from above in the stacking direction in the second step. As described above, by generating the support path data in the first step such that the support structure SC covered with the shaped object MD when viewed from above in the stacking direction is shaped in the second step, it is possible to further prevent the side surface of the contact layer CP and the side surface of the non-contact layer nCP from unintentionally coming into contact with the side surface of the shaped object MD. In particular, by generating the support path data as described above when the shaped object MD has a bridge portion, it is possible to effectively prevent the side surface of the contact layer CP and the side surface of the non-contact layer nCP from unintentionally coming into contact with the side surface of the shaped object MD.

### B. Second Embodiment

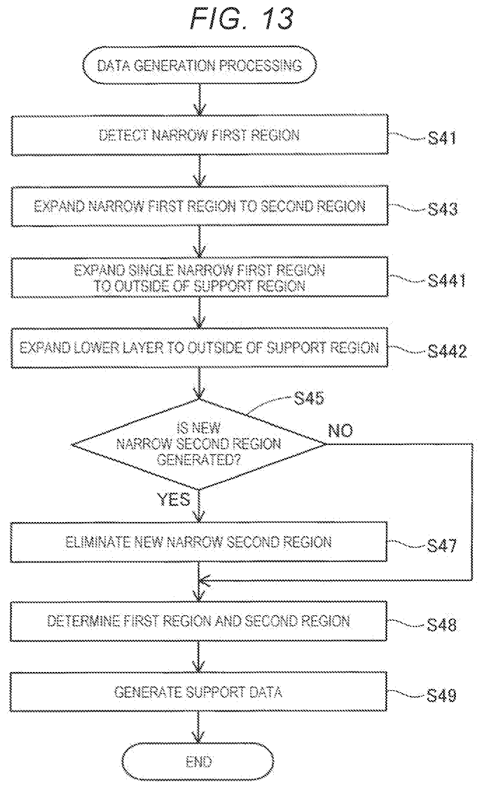

FIG. 13 is a flowchart of data generation processing according to a second embodiment. The data generation processing shown in FIG. 13 is executed in step S40 of FIG. 6, for example, similarly to the data generation processing shown in FIG. 10. In the data generation processing according to the embodiment, unlike the first embodiment, the control unit 300 allows the first region SA1 and the second region SA2 to be expanded to the outside of the initial support region. In FIG. 13, the same steps as those in FIG. 10 described in the first embodiment are denoted by the same reference numerals as those in FIG. 10. In the three-dimensional shaping device 100 and the information processing device 400 according to the embodiment, portions not particularly described are the same as those in the first embodiment.

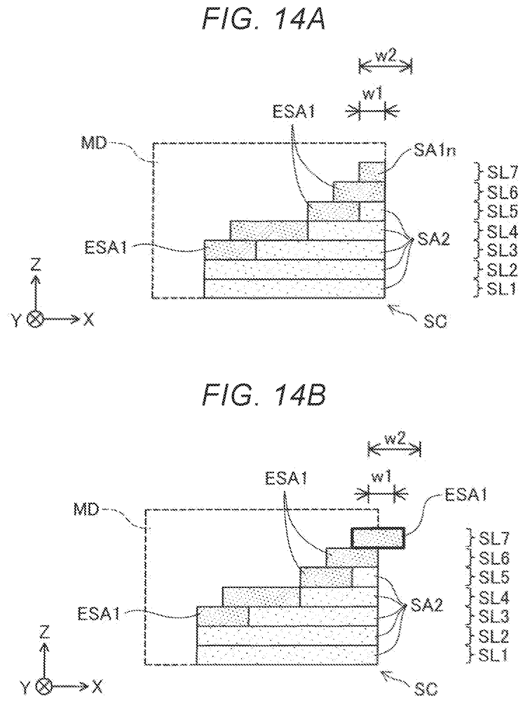

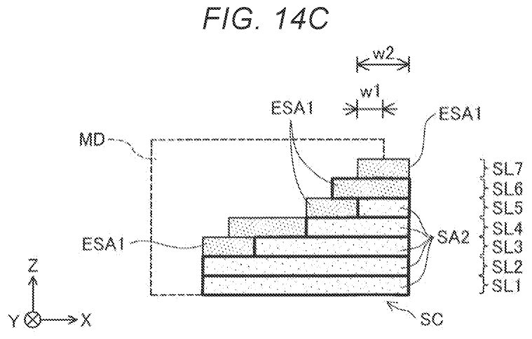

FIG. 14A is a first diagram showing the data generation processing according to the second embodiment. FIG. 14B is a second diagram showing the data generation processing according to the second embodiment. FIG. 14C is a third diagram showing the data generation processing according to the second embodiment. In FIGS. 14A to 14C, similarly to FIGS. 11A to 11C, the first region SA1 and the second region SA2 are indicated by hatching. Similarly to FIGS. 11A to 11C, FIGS. 14A to 14C show an example of the data generation processing when “the number of rounds” is set to one for the first region SA1 and the second region SA2 in step S20 of FIG. 6.

FIG. 14A shows a state in which the narrow first region SA1n is expanded to the second region SA2 in step S43 of FIG. 13 as in FIG. 11B described in the first embodiment. The seventh support layer SL7 shown in FIG. 14A is a single layer having only the narrow first region SA1n as described in the first embodiment. In step S441 of FIG. 13, the data generation unit 411 expands the single narrow first region SA1n to the outside of the initial support region. That is, in step S441, the data generation unit 411 expands the single narrow first region SA1n to a region different from the first region SA1 and the second region SA2 specified in the specifying step. More specifically, in FIG. 14B, the single narrow first region SA1n in the seventh support layer SL7 is expanded to the outside of the support region by being expanded in the +X direction. In FIG. 14B, the expanded region ESA1 generated by expanding the single narrow first region SA1n is indicated by a thick line. In the example shown in FIGS. 14A to 14C, the single narrow first region SA1n is expanded by the width w1, which is the minimum width, similarly to the other narrow first regions SA1n expanded in step S43, and has the width w2 after expansion.

In step S442 of FIG. 13, as shown in FIG. 14C, the data generation unit 411 expands the support region in a layer lower than the expanded region ESA1 generated in step S441 to the outside of the initial support region corresponding to the expanded region ESA1. More specifically, the data generation unit 411 expands the support region in the lower layer such that the contact layer to be shaped in the expanded region ESA1 generated in step S441 can be supported from below. In FIG. 14C, the support region disposed in the most +X direction in each of the first support layer SL1 to the sixth support layer SL6 is expanded in the +X direction by the width w1. More specifically, each of the second regions SA2 in the first support layer SL1 to the fifth support layer SL5 and the expanded region ESA1 in the sixth support layer SL6 is expanded in the +X direction by the width w1 corresponding to the expanded region ESA1 generated in step S441. In FIG. 14C, the first region SA1 and the second regions SA2 in the lower layers expanded in step S442 are indicated by thick lines. In another embodiment, step S442 may be omitted. For example, step S442 may be omitted when the support structure SC can be shaped to be able to support the shaped object MD without expanding the lower layer, or when the single narrow first region SA1n in the lowermost layer of the support layer is expanded.

According to the three-dimensional shaped object manufacturing method in the embodiment described above, in the data generation step, when the width of the single first region SA1 is insufficient to generate the support path data based on the path generation condition, the single first region SA1 is expanded to the outside of the initial support region such that the path data is generated in the single first region SA1. According to such a configuration, it is possible to prevent missing of the contact layer due to the fact that the path data is not generated in the single narrow first region SA1n.

In another embodiment, in addition to or instead of expanding the single narrow first region SA1n to the outside of the initial support region, the single narrow second region SA2n may be expanded to the outside of the initial support region such that the support path data is generated in the single narrow second region SA2n. In this way, it is possible to further prevent partial missing of the support structure SC due to the fact that the path data is not generated in the single narrow second region SA2n. In this case, it is possible to further prevent a portion of the support structure SC that is not in contact with the shaped object MD in the stacking direction from being lost, and in addition, it is easy to stably shape a layer of the support structure above the portion by preventing the missing of the portion. As described above, in the data generation step, by expanding a single narrow region to the outside of the initial support region such that the support path data is generated in the single narrow region, it is possible to prevent partial missing of the support structure SC due to the fact that the path data is not generated in the single region whose width is insufficient.

In another embodiment, the expansion of the single narrow region described above may be executed at any timing before the first region SA1 and the second region SA2 are determined. For example, the expansion of the single narrow region may be executed simultaneously with step S43, or may be executed after the new narrow second region SA2n is eliminated in step S47.

### C. Other Embodiments

(C-1) In the above embodiments, when the narrow second region SA2n is eliminated by expanding the first region SA1, the first region SA1 is expanded to the entire narrow second region SA2n. Alternatively, the narrow second region SA2n may be eliminated by expanding the first region SA1 beyond the narrow second region SA2n.
(C-2) In the above embodiments, when a new narrow second region SA2n is generated, the narrow second region SA2n is eliminated by further expanding the expanded region ESA1. Alternatively, for example, when a new narrow second region SA2n is adjacent to the unexpanded first region SA1, the narrow second region SA2n may be eliminated by expanding the unexpanded first region SA1. For example, even when a new narrow second region SA2n is generated, the new narrow second region SA2n may not be eliminated.
(C-3) In the above embodiments, when the width of the second region SA2 specified in the specifying step is insufficient, the second region SA2 is eliminated by expanding the first region SA1 adjacent to the second region SA2. Alternatively, even when the width of the second region SA2 specified in the specifying step is insufficient, the second region SA2 may not be eliminated.
(C-4) In the above embodiments, among the plurality of first regions SA1 specified in the specifying step, the narrow first region SA1n is expanded to the second region SA2, and the wide first region SA1 is not expanded. Alternatively, in addition to the narrow first region SA1n specified in the specifying step, the wide first region SA1 specified in the specifying step may be expanded. For example, when the wide first region SA1 and the narrow second region SA2n are disposed adjacent to each other in the support layer, the narrow second region SA2n may be eliminated by expanding the wide first region SA1. As described in the second embodiment, when the single region is expanded to the outside of the initial support region, the wide first region SA1 specified in the specifying step may be expanded in order to support, from below, the single region expanded to the outside of the support region. For example, when the first region SA1 adjacent to the second region SA2 is specified in the specifying step, in addition to the narrow first region SA1n, the wide first region SA1 may be expanded to the second region SA2 by expanding the first region SA1 to the second region SA2 regardless of whether the first region SA1 is the narrow first region SA1n or the wide first region SA1.
(C-5) In the above embodiments, after the first region SA1 and the second region SA2 are specified for all the layers of the support structure SC in the specifying processing, the path data is generated in each layer of the support structure CS in the data generation processing. Alternatively, the specifying processing and the data generation processing may not be executed in this manner, and for example, the specifying processing and the data generation processing for one layer of the support structure SC may be repeatedly executed for the total number of layers of the support structure SC.
(C-6) In the above embodiments, in step S35 of FIG. 7, the support structure SC is generated such that the entire lower surface of the overhang portion OH is supported from below by the support structure SC. Alternatively, the support structure SC may not be generated in this manner. For example, the support structure SC may be generated such that a portion of the lower surface of the overhang portion OH in which an angle of inclination with respect to the XY plane is equal to or less than a predetermined angle is supported by the support structure SC.
(C-7) In the above embodiments, “the number of rounds” can be set to one or more, and for example, “the number of rounds” may be set to zero. In this case, in the support region in which “the number of rounds” is set to zero, the contour region is not shaped, and only the internal region is shaped. In this case, the minimum number of paths is one. Even when the minimum number of paths is set to one, in a step of detecting the narrow first region SA1n as in step S41 of FIG. 10, it is determined that the width of the first region SA1 is insufficient when a width of a certain first region SA1 is less than a total width of paths corresponding to the minimum number of paths, as described in the first embodiment. That is, in this case, the first region SA1 whose width is less than the width w1 corresponding to the line width is detected as the narrow first region SA1n.
(C-8) Although the three-dimensional shaping device 100 according to the above embodiment includes one shaping unit 110, the three-dimensional shaping device 100 may include three shaping units 110. In this case, a shaping material for shaping the shaped object MD is ejected from a first shaping unit 110, a first support material for shaping the contact layer CP is ejected from a second shaping unit 110, and a second support material for shaping the non-contact layer nCP is ejected from a third shaping unit 110. When the three-dimensional shaping device 100 includes a plurality of shaping units 110, the shaping conditions may include a condition related to a material of the support layer. The contact layer CP and the non-contact layer nCP can be shaped using different materials. For example, a material having an adhesion strength to the shaping material lower than the second support material can be used as the first support material. One of the first support material and the second support material may be a material the same as the shaping material. In this case, at least two shaping units 110 may be provided in the three-dimensional shaping device 100.
(C-9) In the above embodiment, the shaping unit 110 plasticizes the material by the flat screw 40. Alternatively, the shaping unit 110 may plasticize the material by, for example, rotating an in-line screw. The shaping unit 110 may plasticize a filament-shaped material with a heater.
(C-10) In the above embodiment, for example, a mode in which the first region SA1 and the second region SA2 are not allowed to be expanded to the outside of the initial support region as in the first embodiment and a mode in which the first region SA1 and the second region SA2 are allowed to be expanded to the outside of the initial support region as in the second embodiment may be switchable by the user.

### D. Other Aspects

The present disclosure is not limited to the above embodiments, and can be implemented in various aspects without departing from the scope of the present disclosure. For example, the present disclosure can be implemented in the following aspects. In order to solve a part of or all of problems of the present disclosure, or to achieve a part of or all of effects of the present disclosure, technical features of the above embodiments corresponding to technical features in each of the following aspects can be replaced or combined as appropriate. Technical features can be deleted as appropriate unless described as necessary in the present specification.
(1) According to a first aspect of the present disclosure, there is provided a three-dimensional shaped object manufacturing method of manufacturing a three-dimensional shaped object by stacking layers. The three-dimensional shaped object manufacturing method includes: generating shaping data including path data representing a path along which a nozzle moves while ejecting a shaping material; and shaping, based on the shaping data, a shaped object and a support structure supporting the shaped object. In at least one layer of the support structure, a contact layer in contact with the shaped object above or below the shaped object and a non-contact layer different from the contact layer are disposed adjacent to each other. The generating the shaping data includes a specifying step of specifying, based on data representing a shape of the shaped object, a first region for shaping the contact layer and a second region for shaping the non-contact layer, as a support region for shaping the support structure, and a data generation step of generating the path data in the support region based on a predetermined path generation condition. In the data generation step, when a width of the first region specified in the specifying step is insufficient to generate the path data based on the path generation condition, the first region is expanded to the second region adjacent to the first region such that the path data is generated in the first region.

According to this aspect, even when the width of the first region specified in the specifying step is insufficient to generate the path data, the path data can be generated in the first region by expanding the first region to the second region. Accordingly, it is possible to prevent missing of the contact layer in the support structure due to the fact that the path data is not generated in the first region. Therefore, it is possible to prevent the influence on the accuracy of the shaped object caused by the partial missing of the support structure.
(2) In the above aspect, in the data generation step, when a width of the second region reduced by expanding the first region is insufficient to generate the path data based on the path generation condition, the second region may be eliminated by further expanding the expanded first region to the second region or more. According to this aspect, it is possible to prevent the partial missing of the support structure due to the fact that the path data is not generated in the second region whose width is insufficient due to the reduction.
(3) In the above aspect, in the data generation step, when a width of the second region specified in the specifying step is insufficient to generate the path data based on the path generation condition, the second region may be eliminated by expanding the first region to the second region or more. According to this aspect, it is possible to prevent the partial missing of the support structure due to the fact that the path data is not generated in the second region specified in the specifying step.
(4) In the above aspect, in the specifying step, a plurality of the first regions may be specified, and in the data generation step, among the plurality of first regions specified in the specifying step, the first region whose width is insufficient to generate the path data based on the path generation condition may be expanded to the second region, and the first region whose width is sufficient to generate the path data based on the path generation condition may not be expanded. According to this aspect, only the first region whose width is insufficient to generate the path data can be selectively expanded to the second region. Therefore, for example, a data processing speed in the data generation step can be improved as compared with an aspect in which the first region whose width is sufficient to generate the path data is also expanded.
(5) In the above aspect, at least one layer of the support structure is a single layer having only one of the contact layer and the non-contact layer, and in the data generation step, when a width of a single region for shaping the single layer is insufficient to generate the path data based on the path generation condition, the single region may be expanded to an outside of the support region specified in the specifying step such that the path data is generated in the single region. According to this aspect, it is possible to prevent the partial missing of the support structure due to the fact that the path data is not generated in the single region whose width is insufficient.
(6) In the above aspect, in the data generation step, when the first region is expanded, the first region and the second region may not be expanded to an outside of the support region specified in the specifying step. According to this aspect, it is possible to reduce a time and a material required for shaping the support structure as compared with an aspect in which the first region and the second region are expanded to the outside of the support region specified in the specifying step.
(7) According to a second aspect of the present disclosure, there is provided an information processing device that generates shaping data used in a three-dimensional shaping device for shaping a shaped object and a support structure supporting the shaped object by ejecting a shaping material to stack layers. The information processing device includes a data generation unit configured to generate path data included in the shaping data and representing a path along which a nozzle of the three-dimensional shaping device moves while ejecting the shaping material. The data generation unit is configured to execute specifying processing of specifying, based on data representing a shape of the shaped object, a first region for shaping a contact layer that is in contact with the shaped object above or below the shaped object and a second region for shaping a non-contact layer different from the contact layer, as a support region for shaping the support structure, and data generation processing of generating the path data in the support region based on a predetermined path generation condition. In at least one layer of the support structure, the contact layer and the non-contact layer are disposed adjacent to each other. In the data generation processing, when a width of the first region specified in the specifying processing is insufficient to generate the path data based on the path generation condition, the data generation unit expands the first region to the second region adjacent to the first region such that the path data is generated in the first region.

What is claimed is:

1. A three-dimensional shaped object manufacturing method of manufacturing a three-dimensional shaped object by stacking layers, the three-dimensional shaped object manufacturing method comprising:
generating shaping data including path data representing a path along which nozzle moves while ejecting a shaping material; and
shaping, based on the shaping data, a shaped object and a support structure supporting the shaped object, wherein
in at least one layer of the support structure, a contact layer in contact with the shaped object above or below the shaped object and a non-contact layer different from the contact layer are disposed adjacent to each other,
the generating the shaping data includes
a specifying step of specifying, based on data representing a shape of the shaped object, a first region for shaping the contact layer and a second region for shaping the non-contact layer, as a support region for shaping the support structure, and
a data generation step of generating the path data in the support region based on a predetermined path generation condition, and
in the data generation step, when a width of the first region specified in the specifying step is insufficient to generate the path data based on the path generation condition, the first region is expanded to the second region adjacent to the first region such that the path data is generated in the first region.

2. The three-dimensional shaped object manufacturing method according to claim 1, wherein
in the data generation step, when a width of the second region reduced due to the expansion of the first region is insufficient to generate the path data based on the path generation condition, the second region is eliminated by further expanding the expanded first region.

3. The three-dimensional shaped object manufacturing method according to claim 1, wherein
in the data generation step, when a width of the second region specified in the specifying step is insufficient to generate the path data based on the path generation condition, the second region is eliminated by expanding the first region.

4. The three-dimensional shaped object manufacturing method according to claim 1, wherein
in the specifying step, a plurality of the first regions are specified, and
in the data generation step, among the plurality of first regions specified in the specifying step, the first region whose width is insufficient to generate the path data based on the path generation condition is expanded to the second region, and the first region whose width is sufficient to generate the path data based on the path generation condition is not expanded.

5. The three-dimensional shaped object manufacturing method according to claim 1, wherein
in the data generation step, when the first region is expanded, the first region and the second region are not expanded to an outside of the support region specified in the specifying step.

6. The three-dimensional shaped object manufacturing method according to claim 1, wherein
at least one layer of the support structure is a single layer having only one of the contact layer and the non-contact layer, and
in the data generation step, when a width of a single region for shaping the single layer is insufficient to generate the path data based on the path generation condition, the single region is expanded to an outside of the support region specified in the specifying step such that the path data is generated in the single region.
